(19) United States
(12) Patent Application Publication
(10) Pub. No.: US 2018/0103661 A1
(43) Pub. Date: Apr. 19, 2018

(54) APPARATUS AND METHOD FOR FREEZER GAS CONTROL

(71) Applicants: Michael D. NEWMAN, Hillsborough, NJ (US); Scott BOYLES, Telford, PA (US)

(72) Inventors: Michael D. NEWMAN, Hillsborough, NJ (US); Scott BOYLES, Telford, PA (US)

(21) Appl. No.: 15/295,075

(22) Filed: Oct. 17, 2016

(51) Int. Cl. A23L 3/375; F25D 3/11; F25D 17/06; A23L 3/36; A23B 4/06

(52) U.S. Cl. CPC A23L 3/375; F25D 3/11; A23B 4/062; A23L 3/361; F25D 17/06

(57) ABSTRACT

A freezer having an inlet, an inlet portion having at least one inlet blower, an outlet, an outlet portion having at least one outlet blower, and a conveyor configured to transport products from the inlet to the outlet of the freezer; the inlet blower and the outlet blower configured to circulate gas or a gas and cryogen mixture to impinge onto products transported on the conveyor, wherein at least one of the at least one inlet blower and the at least one outlet blower is configured to be controlled independently of the other to provide no less than a neutral pressure condition at the inlet and outlet portions. A method for controlling gas flow within and minimizing air infiltration into such a freezer by controlling a speed of the inlet blower and the outlet blower independently to provide no less than a neutral pressure condition at the inlet and outlet portions.

### BACKGROUND

The present embodiments relate to an apparatus and method for controlling ambient gas flow into commercial freezers.

Products, such as for example food products, are chilled or frozen within a commercial freezer defined by side walls between a ceiling and floor, and having a cryogen supply and a conveyor extending into the chamber through an inlet portion to an outlet portion disposed between the ceiling and floor. While transporting the products on the conveyor, gas and solid or liquid cryogen are mixed such that the mixture of gas and cryogen are directed to an impinger, and impingement jets of the mixture are directed onto the products transported on the conveyor. In certain instances, the impingement jets are directed through impingement plates and then onto the products. Gas and cryogen are circulated in the freezer by the operation of blowers, conventionally coupled together by a single variable frequency drive, to operate at the same speed.

In certain embodiments, the coolant or cryogen may comprise nitrogen or carbon dioxide. The term “cryogen” is used herein similarly to the term “coolant”, and is not intended to necessarily be limited to materials which have a purely cryogenic effect, although that meaning is intended to be included in the use of “cryogen”. The term “coolant” as used herein means any material or mixture which provides a cooling effect to a product.

It is desired that pressure of the gases within the freezer be maintained from neutral pressure to slightly positive pressure with reference to the ambient pressure, resulting in a small amount of gas and possible cryogen exiting the freezer at the inlet and outlet, while product enters and exits the freezer. Such an arrangement substantially reduces if not eliminates ambient air ingress into the freezer to disrupt the chilling or freezing atmosphere within same. Negative pressure within the freezer would result in ambient air or gases being drawn into the freezer, thereby warming the freezer atmosphere.

Within such freezers, ambient, atmospheric gases entering the freezer are a problem for several reasons. Such gases entering the chamber decrease the overall efficiency of heat transfer from products to the cryogen. Additionally, moisture from the atmosphere condenses and freezes on the impingers, leading to a decreased flow of cryogen out of the impingers and less heat transfer to the cryogen. Moreover, inadvertent warming of a temperature in the freezer atmosphere results in a corresponding increase in cryogen or coolant use to overcome the temperature increase, further resulting in increased operational costs.

Further, over the course of an operating day, there is an imbalance that tends to occur with frozen condensate buildup on the impingers between the inlet and outlet portions of the freezer. Typically, the freezing process is semi-continuous, and the freezer may operate from 16 to 20 hours as product is conveyed through the freezer. During that time period, water may migrate from the product into the process gases, and condense and freeze on the impingement plates positioned above and below the conveyor, collecting frost and altering the pressure drop across the impinger, often preferentially at the inlet portion of the freezer.

In order to maintain the pressure of the gas and/or gas-cryogen mixture in the vicinity of the products transported on the conveyor, it may be necessary to increase the speed of the inlet blower to compensate. In conventional freezers, there is only one speed control for multiple blowers. When the known inlet and outlet blowers are coupled, the speed of same coacts to ensure that a portion of the coolant gas exits the freezer at the inlet, which results in a relatively higher pressure at the outlet as well where the frost buildup is absent or reduced and therefore, coolant gas and cryogen is wasted exiting the outlet. As conditions (e.g., icing, product state) are typically different between the inlet and outlet portions of the freezer, it is extremely difficult to balance an impingement freezer with constant or coupled blower speed controls.

What is therefore needed is a method and apparatus for independently controlling the pressures relative to the atmosphere at both the inlet and outlet portions of the freezer, thereby allowing for a neutral or slightly positive pressure to be consistently maintained throughout the operation of the freezer without wasting the coolant gas or cryogen.

### SUMMARY

Provided is a method for controlling gas flow within and minimizing air infiltration into a freezer comprising an inlet, an inlet portion having at least one inlet blower, an outlet, an outlet portion having at least one outlet blower, and a conveyor configured to move products from the inlet to the outlet of the freezer; the inlet blower and the outlet blower operable for circulating gas or a gas and cryogen mixture to impinge onto products transported on the conveyor, the method comprising: controlling a speed of the inlet blower and the outlet blower independently to provide no less than a neutral pressure condition at the inlet and outlet portions.

In certain embodiments, said controlling the speed is with respect to both the inlet and outlet blowers; and in certain embodiments said controlling the speed occurs concurrently for both the inlet and outlet blowers.

Also provided is a freezer comprising an inlet, an inlet portion having at least one inlet blower, an outlet, an outlet portion having at least one outlet blower, and a conveyor configured to transport products from the inlet to the outlet of the freezer; the inlet blower and outlet blower configured to circulate gas or a gas and cryogen mixture to impinge onto products transported on the conveyor, wherein the at least one inlet blower is configured to be controlled independently of the at least one outlet blower.

In certain embodiments, the inlet portion has a plurality of operationally coupled inlet blowers, and/or the outlet portion has a plurality of operationally coupled outlet blowers.

In certain embodiments, the freezer includes at least one inlet portion pressure sensor positioned at the inlet portion, and/or at least one outlet portion pressure sensor positioned at the outlet portion, the at least one inlet portion pressure sensor and/or the at least one outlet portion pressure sensor being in communication with at least one controller electronically coupled to the at least one inlet blower and/or the at least one outlet blower; the at least one controller configured to maintain a desired pressure at the inlet portion and/or at the outlet portion.

### BRIEF DESCRIPTION OF THE DRAWING(S)

The accompanying drawings are included to provide a further understanding of the apparatus and method provided herein, and are incorporated in and constitute a part of this specification. The drawings illustrate embodiments of the apparatus and method provided herein and, together with the description, serve to explain the principles described herein, but are not intended to limit the specification or any of the claims.

FIG. 1 is an elevational, lateral, cross sectional view of a modular-type freezer embodiment.

FIG. 2 is an elevational view, partially in cross section along A-A of a single module in the freezer of FIG. 1.

FIG. 3 is a view of a logic diagram of a proportional integral differential controller.

### DESCRIPTION

The present embodiments are directed to a method for controlling gas flow within and minimizing air infiltration into a freezer comprising an inlet, an inlet portion having at least one inlet blower, an outlet, an outlet portion having at least one outlet blower, and a conveyor configured to move products from the inlet to the outlet of the freezer; the inlet blower and outlet blower, when in operation, circulating gas or a gas and cryogen mixture to impinge onto products transported on the conveyor. The method includes controlling the speed of the inlet blower independently of the speed of the outlet blower, to achieve neutral or slightly positive pressure conditions at the inlet portion and outlet portion of the freezer. In certain embodiments, the inlet portion has a plurality of operationally coupled inlet blowers, and/or the outlet portion has a plurality of operationally coupled outlet blowers. Thus, the inlet blower(s) is(are) configured to be controlled independently of the outlet blower(s). As a result coolant gas or the gas-cryogen mixture may be discharged substantially evenly out of the freezer inlet and outlet.

In certain embodiments, the freezer is a modular impingement freezer. The transfer of heat from products, such as a food product, to a cryogen may be accomplished by spraying solid or liquid cryogen into gas (such as carbon dioxide or nitrogen) circulated at the item or food product while using an impinger, such as an impingement plate, to create a stream of cryogen. The design of the device increases the heat transferred from the product to the cryogen. The cryogen, for example solid carbon dioxide snow or liquid nitrogen, is introduced into an impinging flow of gas, wherein heat transfer occurs with respect to the gas and the product, to cool the product during impingement.

The at least one inlet blower and the at least one outlet blower circulate the gas or the gas-cryogen mixture to impingement plates above and below the conveyor, the impingement plates containing openings through which impingement jets of the gas or the gas-cryogen mixture are directed toward and/or onto the products transported on the conveyor.

The transfer of heat from a product, such as for example a food product, to a cryogen may be further accomplished with the use of sequential modules. Modularity enables an arrangement to meet specific freezing requirements for various products. In certain embodiments, at least one module, such as the inlet module, may have liquid cryogen piping and sprayer(s) which enable a stream of liquid cryogen to be sprayed into the jet of gaseous cryogen circulating within the module and toward the conveyor and product. The conveyor may be an open mesh or have open links such that gaseous cryogen will have access also to the product from below (or an opposed side of the product). Each module contains at least one impinger which enables jets of cryogenic gas to impinge the upper and/or lower (opposed) surfaces of the product. The impinger may be an impingement plate having a specific configuration of stamped or chamfered holes. The sprayer(s) may comprise a plurality of full cone, low flow rate spray nozzles. The use of this configuration enables a rapid heat transfer from the exterior of the product, resulting in rapid cooling and/or crust freezing of product upon entering the series of modules and decreases any dehydration of the product.

The mixture of gas and cryogen may be re-circulated after initial impingement in order to more efficiently transfer heat from the product relative to the amount of mixture used, with any known recirculation apparatus, and for more efficient use of gas and cryogen for the mixture.

One intermediate module or a plurality of intermediate modules may be in arranged in series or an array, with the inlet module arranged upstream of and before the outlet module. The intermediate and outlet modules may comprise a similar system of piping, impinger, sprayer, and nozzle, but enable a certain length of freezing time depending on the conveyor speed, throughput of product required, and the amount of time (residence time) such product requires in the cryogenic environment in order to reach a desired temperature or processing condition. The modularity of the freezer provides for any variation in these parameters.

In order to improve the performance of freezers from both a cost and efficiency standpoint, the present embodiments include controlling the speed of the inlet blower independently of the speed of the outlet blower to achieve neutral or slightly positive pressure conditions at the inlet portion and outlet portion, when comparing such inlet and outlet pressure conditions to a pressure at the exterior of the freezer.

The speeds of the inlet and outlet blower(s) may be independently controlled manually. For example, the speed of the inlet blower(s) may be adjusted, such as through an input from an human-machine interface (HMI) to a variable frequency drive or by using a potentiometer where speed of the blower is controlled by the voltage input to the blower until gas, such as nitrogen coolant, is observed being exhausted from the inlet of the freezer, thereby indicating that ambient air is not being taken into the freezer at the inlet portion. The speed of the outlet blower(s) can be held constant, so as to maintain the desired neutral or slightly positive pressure, with coolant gas being observed being exhausted from the outlet of the freezer. Typically, a greater portion of gas will exit the freezer at the outlet, and there is no need to have an equal amount exhausting from both the inlet and the outlet. If coolant does not exhaust from the outlet, the speed of the outlet blower(s) may be increased independently of the speed of the inlet blower(s).

Controlling the speeds of the inlet and outlet blowers also contributes to the balance of gas flow through the freezer for purposes of efficiency and economy. The aggressive gas flow in an impingement freezing process makes “balancing the freezer” difficult to achieve. Initially, in some embodiments, considering an 85 hertz blower motor, the input blower(s) may be operated at about 65 hertz, and the outlet blower(s) at about 55-60 hertz, for a speed difference of about 10-20%.

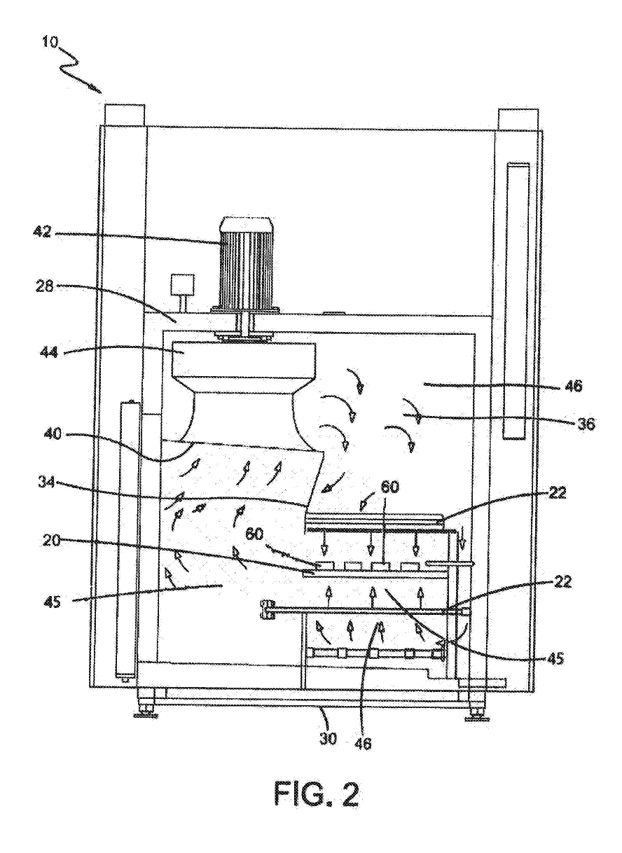

It is typically desired to maintain a neutral to slightly positive pressure in the area proximate to the conveyor, and a higher pressure above and below the impingement plates, distal to the conveyor. According to certain embodiments, it may be desired to maintain pressure between the blowers and the impingement plates at between about 1 to about 5 inches water column (about 25 to about 1250 Pa), in some embodiments between about 2 to about 3 inches water column (about 495 to about 750 Pa), and to maintain pressure around the conveyor, that is, between the impingement plates, at between about minus 0.15 to about 0.2 inches water column (about minus 37 Pa to about 50 Pa), such as about 0.1 inches water column (about 25 Pa). Although the recited pressures are small, these pressures have a significant impact on the ingress of air into and exhaust of gas out of the freezer, as the flow of gas through the freezer occurs mainly in the area proximate to and around the conveyor. It is generally desired to maintain a slightly higher pressure in the inlet portion of the freezer as compared to the outlet portion, so that the product is exposed initially to a higher pressure, which pressure becomes lower as the product travels a length of the freezer. However, it is ideal to establish near atmospheric conditions inside the freezer at the inlet and outlet portions of the freezer. Such is difficult, as this area lies between a high and low pressure area within the same flow path, as further described below with respect to FIG. 2.

In certain embodiments, the freezer contains at least one inlet pressure sensor at the inlet portion, and/or at least one outlet pressure sensor at the outlet portion, the at least one inlet pressure sensor and/or the at least one outlet pressure sensor being in communication with at least one controller electronically coupled to the at least one inlet blower and/or the at least one outlet blower; the at least one controller configured to maintain a desired pressure at the inlet portion and/or at the outlet portion. The pressure sensors may be positioned just inside the freezer at the inlet and outlet, and may be located proximate to the area proximate and surrounding the conveyor. The speed of the inlet blower(s) and outlet blower(s) may be independently controlled automatically, based on the pressure sensed at the inlet portion and at the outlet portion, to maintain neutral pressures and keep the freezer pressures balanced over the course of a production day.

According the present embodiments, it may be desired to control the speed of the at least one inlet blower to be greater than a speed of the at least one outlet blower in order to maintain desired pressure at the inlet and outlet portions, as snow or ice from moisture or cryogen will form on the impingement plate as discussed above, mainly in the inlet portion over the course of the operating period.

When pressure changes are sensed in the area proximate to the conveyor, such as due to icing of the impingement plates in the inlet portion of the freezer, the controller can increase the speed of the inlet blower(s) to compensate for the icing and to balance the air flow in the freezer.

In certain embodiments, a dedicated controller may be used for the inlet portion and a separate dedicated controller for the outlet portion.

Known freezers may include a pair of inlet blowers and a pair of outlet blowers. According to the disclosed embodiments, the control (of the speeds) of each pair may be coupled, such as each pair being operated from separate variable frequency drives, or each blower may be operated independently for greater fine tuning of each blower and hence the freezer. In some embodiments, a speed of one blower of a pair of blowers, such as the front inlet blower(s), may be modified to compensate for pressure changes. For example, the speed of the front blower could be increased by doubling its speed, instead of increasing the speed of each blower of the input blower pair by 50%.

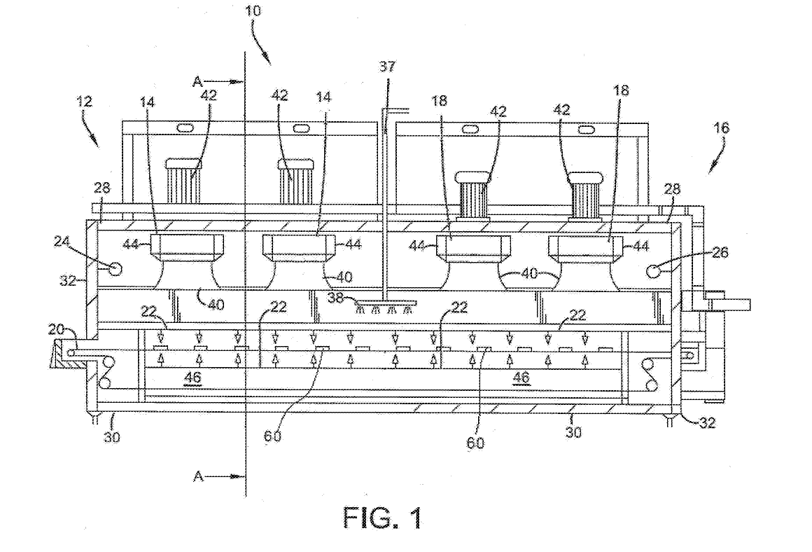

In particular and referring to FIGS. 1 and 2, there is shown a freezer embodiment directed to a freezer 10 having at least a partial enclosure 28 or housing, wherein said freezer 10 comprises: an inlet portion 12 containing at least one inlet blower 14; an outlet portion 16 containing at least one outlet blower 18, wherein the at least one outlet blower 18 is configured to be controlled independently of the at least one inlet blower 14; and a conveyor 20 configured to move products 60 from the inlet portion 12 to the outlet portion 16 of the freezer 10. The conveyor is positioned and moves between upper and lower impingers 22, each comprising an impingement plate. The embodiment includes a motor 42 that drives an impeller 44 for each of the blowers 14, 18 in order to direct a cryogen mixture 36 (shown in FIG. 2) through the impinger 22 toward and/or onto the products 60 being transported on the conveyor 20. The impeller 44 also collects the mixture 36 for recirculation, in order to ensure efficient use of the mixture.

The freezer may comprise a plurality or series of modules including blower(s) such as blower(s) 14 associated with the inlet of the freezer 10 and/or blower(s) 18 associated with the outlet portion 16 of the freezer 10. Each blower is constructed for co-action and in fluid communication with a corresponding intake cone 40 and low pressure plenum 45, and generates a flow of cryogen from its exit by which it circulates a flow of the cryogenic mixture 36 as a vapor around an interior of the freezer module in accordance with the flow patterns represented by arrows in FIG. 2. The cryogenic vapor 36 flows from the blower impeller 44 exit past sprayer 38 whereupon liquid cryogen is entrained into the stream and through impinger 22 positioned above the conveyor 20, thereby impinging cryogen on the products 60, such as food items being transported on the conveyor from the inlet portion 12 to the outlet portion 16 of the freezer 10. A high pressure flow of the gas and cryogen mixture 36 which enters the high pressure plenum 46, also flows through an impinger 22 positioned below the conveyor 20, providing impingement jets toward the underside of the products 60 transported on the conveyor 20. The conveyor 20 may be, without limitation, a woven stainless steel belt used in food freezers. The warmed gas flows to the low pressure plenum 45, separated from the high pressure plenum 46 in part by baffle 34, and is taken up by impeller 44 through the intake cone 40.

Piping 37 is connected to a supply of liquid cryogen (not shown) providing a conduit for a supply of the liquid cryogen for the sprayer 38 and to provide a source of cryogenic vapor 36 for circulation within the freezer 10, typically within the inlet portion 12 and optionally within each freezer 10 module.

In certain embodiments, one intermediate module or a plurality of intermediate modules may be arranged in series, in an array or nested together between the inlet portion 12 and the outlet portion 16 modules. The intermediate and outlet portion 16 modules may comprise a similar system of piping, sprayer 38, and impingers 22, contain a portion of the conveyor 20, and enable a certain amount of freezing time depending on the conveyor 20 speed or throughput of the product required, and the amount of time such product requires to be in the cryogenic environment to reach a desired temperature. The modularity of the freezer provides for any variation in these parameters. Further, modularity allows for local recirculation of the mixture 36 by allowing recirculation of cryogen to a low pressure area of an individual module for uptake by the impeller 44 through the intake cone 40.

In an intermediate module, the impeller 44 powered by the motor 42 circulates the cryogenic mixture 36 according to the arrows shown in FIG. 2 which is a cross-section of intermediate module taken through line A-A of FIG. 1. A top plate 28 and a bottom plate 30 provide a corresponding top 28 and bottom 30 for the module. The top plate 28 is where a blower is mounted and through which a drive shaft extends to connect the motor 42 with the impeller 44 positioned in the interior of the freezer 10. The impeller provides, in part, a structural interface between the low pressure plenum 45 and the high pressure plenum 46, and creates the high pressure flow of gas or gas-cryogen. As in the other modules, the impingers 22 generate impingement jets from the increased velocity of the cryogenic gas prior to impingement of the gas toward and onto the products 60 transported on the conveyor 20. The products 60 pass continuously from one module to another on the conveyor 20 through an opening on the low-pressure side of impingers 22.

As mentioned above, extending through the top plate 28 is a drive shaft interconnecting the motor 42 with the impeller 44. The motor 42 may be located at an exterior of the enclosure 28, and is provided with an electrical supply (not shown). The motor 42 drives the impeller 44 of the blower to circulate gas inside the freezer 10.

The pressure at either of the inlet portion 12 or the outlet portion 16 of the freezer 10 is changed by adjusting the speed of at least one independently controlled blower 14, 18 associated with that portion of the freezer 10. Such adjustment will provide for “balancing” the freezer 10. Without limitation, each of the blowers 14, 18 may be an impeller that is a 762 mm diameter centrifugal fan operating at 283 cubic meters per minute at 88 hertz at 0.5 kpa static pressure having a 7.45 KW inverter driven motor 42, or other type of blower having similar characteristics. The speed of the blowers 14, 18, and therefore, the pressure at either the inlet portion 12 or outlet portion 16 of the freezer 10, is independently controllable by altering the voltage drop across a respective one of the blowers 14, 18.

The freezer 10 may contain at least one pressure sensor 24 (the inlet sensor) located at or near the inlet portion 12 of the freezer 10 to detect the pressure relative to the ambient, atmospheric pressure at the inlet portion. Similarly, the freezer 10 may contain at least one pressure sensor 26 (the outlet sensor) located at or near the outlet portion 16 of the freezer 10 to detect the pressure relative to the ambient, atmospheric pressure at the outlet portion 16. The sensors 24, 26 may be any conventional pressure sensor that is capable of measuring small differences in pressure in the ranges discussed herein, at the low temperature environment of the freezer 10. A non-limiting, illustrative example of such sensors are TruStability® series Ultra-Low to Low Pressure sensors commercially available from Honeywell Sensing and Productivity Solutions, Fort Mill, S.C., U.S.A.

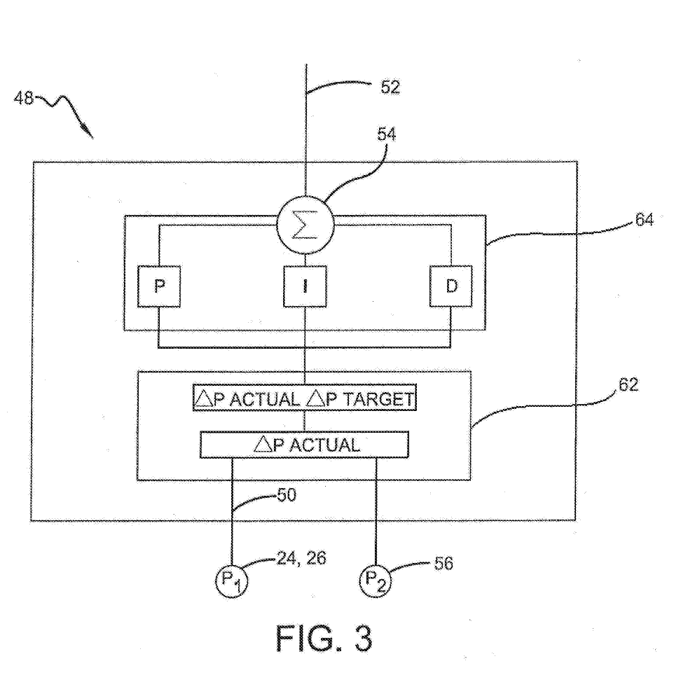

Referring now to FIG. 3, some embodiments may include an inlet and/or outlet controller an embodiment of which is shown generally at 48. Any such controller 48 includes a data inlet 50, which is in communication with the associated (inlet or outlet) pressure sensor 24, 26. FIG. 3 illustrates the controller 48 comprising data inlets 50, a controller output 52, and user-defined data inlet (not shown). The controller output 52 is in communication with at least one associated inlet blower 14, and/or at least one associated outlet blower 18, to adjust the speed of the blower 14, 18 to maintain a constant, user-defined target difference in pressure between the associated pressure sensor 24, 26 and an external ambient, atmospheric pressure. The controller 48 further comprises a comparison unit 62 for calculating the difference between the user-defined target difference in pressure (ΔP-target) between the pressure detected at the pressure sensor 24, 26 and the ambient, atmospheric pressure detected at sensor 56, and the real-time measured pressure difference between the same (ΔP-actual). Any error calculated by the comparison unit 62 is transmitted to a composite PID unit 64 in electronic communication with the comparison unit. The composite PID unit 64, after calculating the summation of the error correction signals generated by each of the other components in summation unit 54, transmits a signal to the blower 14, 18 to automatically adjust a speed of same whereby a constant, user-defined target difference in pressure is maintained between the associated portion of the freezer 10 and the external, ambient atmospheric pressure.

The pressure measurements transmitted to the controller 48 by the pressure sensor(s) 24, 26, are first compared in the comparison unit 62 in order to obtain a ΔP-actual according to the formula:

ΔP-actual=Pressure at sensor−Ambient Pressure

The ΔP-actual is then transmitted to a second phase of the comparison unit 62 in order to compare the ΔP-actual with the user-defined, target ΔP-target, which is programmed into the controller 48 through user-defined input. Comparison of ΔP-actual and ΔP-target in the comparison unit 62 produces the value of the error function at any given point in time according to the equation:

Error(t)=ΔP-target−ΔP-actual

If the controller 48 is a standard PID controller as shown in FIG. 3, the value of Error(t) is transmitted to three (3) separate portions of the composite PID unit 64. The composite PID unit 64 performs three distinct calculations with Error(t) (the asterisk indicating multiplication), a proportional portion according to the expression:

Kp*Error(t);

an integral portion according to the expression:

$$Ki * {\int }_{0}^{t} Error ( t ) dt ;$$

and a derivative portion according to the expression:

Kd*d(Error(t))/dt;

wherein Kp, Ki, and Kd are numerical constants representing relative weights given to various portions of the composite PID unit multiplied by each portion. Each of the individual portions are summed in the PID summation unit 64, and transmitted via controller output 52 to the at least one blower 14, 16, in order to maintain a constant, user-defined pressure difference between the associated pressure sensor(s) 24, 26 and the ambient, atmospheric pressure.

In a first embodiment, there is provided a method for controlling gas flow within and minimizing air infiltration into a freezer comprising an inlet, an inlet portion having at least one inlet blower, an outlet, an outlet portion having at least one outlet blower, and a conveyor configured to move products from the inlet to the outlet of the freezer; the inlet blower and the outlet blower operable for circulating gas or a gas and cryogen mixture to impinge onto products transported on the conveyor, the method comprising: controlling a speed of the inlet blower and the outlet blower independently to provide no less than a neutral pressure condition at the inlet and outlet portions.

In the method of the first embodiment, there is included discharging gas or the gas-cryogen mixture substantially evenly out of the freezer inlet and outlet.

In the method of either the first or subsequent embodiment, the freezer is a modular impingement freezer.

In the method of any of the first or subsequent embodiments, the at least one inlet blower and the at least one outlet blower circulates the gas or the gas-cryogen mixture to impingement plates above and below the conveyor, the impingement plates containing openings for directing impingement jets of the gas or the gas-cryogen mixture toward the products transported on the conveyor.

In the method of any of the first or subsequent embodiments, there is included maintaining pressure between the blowers and the impingement plates at between about 1 to about 5 inches water column (about 25 to about 1250 Pa).

In the method of any of the first or subsequent embodiments, there is included maintaining pressure between the blowers and the impingement plates at between about 2 to about 3 inches water column (about 495 to about 750 Pa).

In the method of any of the first or subsequent embodiments, there is included maintaining pressure around the conveyor, between the impingement plates, at between about minus 0.15 to about 0.2 inches water column (about minus 37 Pa to about 50 Pa).

In the method of any of the first or subsequent embodiments, there is included controlling the speed of the at least one inlet blower to be higher relative to the speed of the at least one outlet blower to maintain desired pressure at the inlet and outlet portions, as snow or ice from moisture or cryogen form on the impingement plate.

In the method of any of the first or subsequent embodiments, the freezer contains at least one inlet portion pressure sensor in the inlet portion, and/or at least one outlet portion pressure sensor in the outlet portion, the at least one inlet portion pressure sensor and/or the at least one outlet portion pressure sensor being in communication with at least one controller electronically coupled to the at least one inlet blower and/or the at least one outlet blower; the at least one controller configured to maintain a desired pressure at the inlet portion and/or at the outlet portion.

In the method of any of the first or subsequent embodiments, the inlet portion has a plurality of operationally coupled inlet blowers, and/or the outlet portion has a plurality of operationally coupled outlet blowers.

In a second embodiment, there is provided a freezer comprising an inlet, an inlet portion having at least one inlet blower, an outlet, an outlet portion having at least one outlet blower, and a conveyor configured to transport products from the inlet to the outlet of the freezer; the inlet blower and the outlet blower configured to circulate gas or a gas and cryogen mixture to impinge onto products transported on the conveyor, wherein at least one of the at least one inlet blower and the at least one outlet blower is configured to be controlled independently of the other to provide no less than a neutral pressure condition at the inlet and outlet portions.

In the freezer of the second embodiment, said freezer is a modular impingement freezer.

In the freezer of either the second or a subsequent embodiment, the at least one inlet blower and the at least one outlet blower are configured to circulate the gas or the gas-cryogen mixture to impingement plates above and below the conveyor, the impingement plates containing openings for directing impingement jets of the gas or the gas-cryogen mixture toward the products transported on the conveyor.

In the freezer of either the second or a subsequent embodiment, the freezer contains at least one inlet portion pressure sensor in the inlet portion, and/or at least one outlet portion pressure sensor in the outlet portion, the at least one inlet portion pressure sensor and/or the at least one outlet portion pressure sensor being in communication with at least one controller electronically coupled to the at least one inlet blower and/or the at least one outlet blower; the at least one controller configured to maintain a desired pressure at the inlet portion and/or at the outlet portion.

In the freezer of either the second or a subsequent embodiment, the inlet portion has a plurality of operationally coupled inlet blowers, and/or the outlet portion has a plurality of operationally coupled outlet blowers.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. A method for controlling gas flow within and minimizing air infiltration into a freezer comprising an inlet, an inlet portion having at least one inlet blower, an outlet, an outlet portion having at least one outlet blower, and a conveyor configured to move products from the inlet to the outlet of the freezer; the inlet blower and the outlet blower operable for circulating gas or a gas and cryogen mixture to impinge onto products transported on the conveyor, the method comprising: controlling a speed of the inlet blower and the outlet blower independently to provide no less than a neutral pressure condition at the inlet and outlet portions.

2. The method of claim 1, including discharging gas or the gas-cryogen mixture substantially evenly out of the freezer inlet and outlet.

3. The method of claim 1, wherein the freezer is a modular impingement freezer.

4. The method of claim 3, wherein the at least one inlet blower and the at least one outlet blower circulates the gas or the gas-cryogen mixture to impingement plates above and below the conveyor, the impingement plates containing openings for directing impingement jets of the gas or the gas-cryogen mixture toward the products transported on the conveyor.

5. The method of claim 4, including maintaining pressure between the blowers and the impingement plates at between about 1 to about 5 inches water column (about 25 to about 1250 Pa).

6. The method of claim 4, including maintaining pressure between the blowers and the impingement plates at between about 2 to about 3 inches water column (about 495 to about 750 Pa).

7. The method of claim 4, including maintaining pressure around the conveyor, between the impingement plates, at between about minus 0.15 to about 0.2 inches water column (about minus 37 Pa to about 50 Pa).

8. The method of claim 4, including controlling the speed of the at least one inlet blower to be higher relative to the speed of the at least one outlet blower to maintain desired pressure at the inlet and outlet portions, as snow or ice from moisture or cryogen form on the impingement plate.

9. The method of claim 1, wherein the freezer contains at least one inlet portion pressure sensor in the inlet portion, and/or at least one outlet portion pressure sensor in the outlet portion, the at least one inlet portion pressure sensor and/or the at least one outlet portion pressure sensor being in communication with at least one controller electronically coupled to the at least one inlet blower and/or the at least one outlet blower; the at least one controller configured to maintain a desired pressure at the inlet portion and/or at the outlet portion.

10. The method of claim 1, wherein the inlet portion has a plurality of operationally coupled inlet blowers, and/or the outlet portion has a plurality of operationally coupled outlet blowers.

11. A freezer comprising an inlet, an inlet portion having at least one inlet blower, an outlet, an outlet portion having at least one outlet blower, and a conveyor configured to transport products from the inlet to the outlet of the freezer; the inlet blower and outlet blower configured to circulate gas or a gas and cryogen mixture to impinge onto products transported on the conveyor, wherein at least one of the at least one inlet blower and the at least one outlet blower is configured to be controlled independently of the other to provide no less than a neutral pressure condition at the inlet and outlet portions.

12. The freezer of claim 11, wherein said freezer is a modular impingement freezer.

13. The freezer of claim 12, wherein the at least one inlet blower and the at least one outlet blower are configured to circulate the gas or the gas-cryogen mixture to impingement plates above and below the conveyor, the impingement plates containing openings for directing impingement jets of the gas or the gas-cryogen mixture toward the products transported on the conveyor.

14. The freezer of claim 11, wherein the freezer contains at least one inlet portion pressure sensor in the inlet portion, and/or at least one outlet portion pressure sensor in the outlet portion, the at least one inlet portion pressure sensor and/or the at least one outlet portion pressure sensor being in communication with at least one controller electronically coupled to the at least one inlet blower and/or the at least one outlet blower; the at least one controller configured to maintain a desired pressure at the inlet portion and/or at the outlet portion.

15. The freezer of claim 11, wherein the inlet portion has a plurality of operationally coupled inlet blowers, and/or the outlet portion has a plurality of operationally coupled outlet blowers.
